(19) United States
(12) Patent Application Publication
(10) Pub. No.: US 2015/0365523 A1
(43) Pub. Date: Dec. 17, 2015

(54) Method of Routing Voice Calls

(71) Applicant: Samvel Sahakyan, Scarsdale, NY (US)

(72) Inventor: Samvel Sahakyan, Scarsdale, NY (US)

(21) Appl. No.: 14/736,685

(22) Filed: Jun. 11, 2015

Related U.S. Application Data
(60) Provisional application No. 62/013,044, filed on Jun. 17, 2014.

(51) Int. Cl. H04M 3/42

(52) U.S. Cl. CPC H04M 3/42059; H04M 3/42297

(57) ABSTRACT

The invention presents a method of routing voice calls. In one embodiment, the method includes the steps of a routing system receiving a request for preparing/updating a routing rule based on a Source Number and a Destination Number (DN). The routing system sends an access number to the user. A call handling system receives a call from the user to the access number, identifies the user by the user's Source Number or Caller ID, requests the Destination Number from the routing system based on the Source Number or Caller ID Routing. Then, the call handling system connects the User and the Recipient.

### REFERENCE TO RELATED APPLICATIONS

This application claims one or more inventions which were disclosed in Provisional Application No. 62/013,044, filed Jun. 17, 2014, entitled “Method of Calls Routing”. The benefit under 35 USC §119(e) of the United States provisional application is hereby claimed, and the aforementioned application is hereby incorporated herein by reference.

### BACKGROUND OF THE INVENTION

### Field of the Invention

The present invention is in the technical field of voice calls. More particularly, the present invention is in the technical field of voice calls routing.

### Summary of the Invention

The invention presents a method of routing voice calls. In one embodiment, the method includes the steps of a routing system receiving a request for preparing/updating a routing rule based on a Source Number and a Destination Number (DN). The routing system sends an access number to the user. A call handling system receives a call from the user to the access number, identifies the user by the user's Source Number or Caller ID, requests the Destination Number from the routing system based on the Source Number or Caller ID Routing. Then, the call handling system connects the User and the Recipient.

In one embodiment of the present invention, it is suitable for handling and routing calls based on Source Number or Caller ID of the caller.

### BRIEF DESCRIPTION OF THE DRAWING

FIG. 1 shows a block diagram of the implementation of the method of the invention.

FIG. 2 shows a flowchart of the method of the invention.

### DETAILED DESCRIPTION OF THE INVENTION

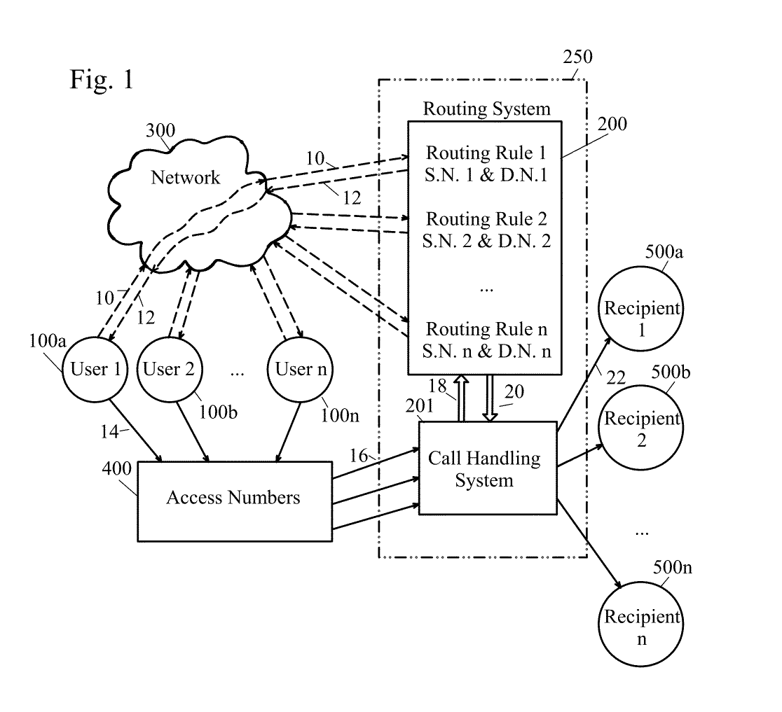

Referring now to FIG. 1 for a the block diagram of an implementation of the invention in one particular embodiment, in which a call management system 250 comprising a routing system 200 and a call handling system 201 connected to a plurality of access numbers 400. There are shown a number of users 100a . . . 100n sending call arrangement requests to the Routing System 200 through Network 300. The Routing System 200 has a plurality of Routing Rules, shown as Routing Rule 1, Routing Rule 2 . . . Routing Rule n, in the figure.

The users 100a . . . 100n can call Access Numbers 400, and the Call Handling System 201 can route calls from a user 10a . . . 100n connected to one of the Access Numbers 400 to the destination number of one of the Recipients 500a . . . 500n.

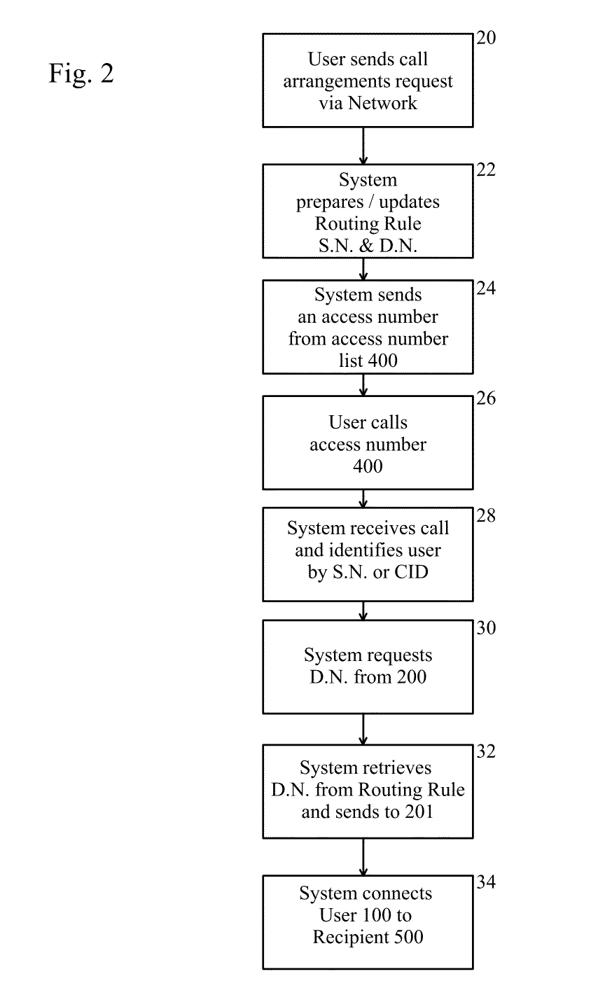

Referring now to the flowchart of FIG. 2, the method of the invention progresses by the following steps:

Step 20: a user 100a sends a call arrangement request 10 from a source number (S.N.) to the Routing system 200 via network 300. The call arrangement request 10 may contain at least a destination number for the recipient 500a to which the user 100a wants to be connected.

Step 22: Routing System 200 receives the call arrangement request 10 from the user 100a, and assigns a Routing rule to the call arrangement request based on the Source number of the user 100a and the Destination number (D.N.) for the recipient 500a specified in the call arrangement request. The Routing System 200 determines the Source Number from which the call was placed by using Caller ID, for example, or by some other method. Alternatively, the user 100a may enter the Source Number as part of the call arrangement request. The routing rule may be created or updated by the routing system, or, optionally the call arrangement request 10 may identify a custom routing rule previously stored in the Routing System 200, for example by the user 100a. It will be recognized that the source number and destination number may be domestic or international, and the method can be used to route calls within the same country or even the same local network or private exchange, within the teachings of the invention.

Step 24: Routing System 200 assigns an access number 400 and sends it 12 to the user 100a. The access number 400 may be selected sequentially or randomly from a list of available access numbers, or may be assigned by some other means.

Step 26: User 100a calls 14 the Access number which was sent by the Routing System 200.

Step 28: Call Handling System 201 receives 16 the call made by user 100a to the Access number 400. The Call Handling System identifies the call by determining the Source Number from which the call was placed, for example by using Caller ID or some other method.

Step 30: Call Handling System 201 sends a request 18 for the Destination Number (D.N.) for the call to the Routing System 200.

Step 32: Routing System 200 retrieves the Destination Number 20 for the call and sends it to the Call Handling System 201.

Step 34: Call Handling System 201 uses the Destination Number 20 received from the Routing System 200 to route a path 22 to connect the call 14 of user 100a on the access number 400 to the recipient 500a at the Destination Number.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of routing voice calls from a user at a source number through a call management system comprising a routing system and a call handling system to a recipient at a destination number, comprising the steps of:
a) the routing system receiving a call arrangement request from a user at a source number, the call arrangement request comprising at least a destination number for a recipient;
b) the routing system assigning a routing rule to the call arrangement request;
c) the routing system assigning an access number to the call arrangement request;
d) the routing system sending the access number to the user;
e) the call handling system receiving a call made by the user to the access number;
f) the call handling system identifying the call;
g) the call handling system sending a request for the destination number for the call from the routing system;
h) the routing system retrieving the destination number for the call in response to the request from the call handling system using the routing rule;
i) the routing system sending the destination number for the call to the call handling system; and
j) the call handling system using the destination number received from the routing system to connect the call of the user on the access number to the recipient at the destination number.

2. The method of claim 1, in which the step of the routing system assigning a routing rule comprises the routing system creating a routing rule based on the source number of the user and the destination number for the recipient specified in the call arrangement request.

3. The method of claim 1, in which the step of the routing system assigning a routing rule comprises the routing system updating a previously existing routing rule based on the source number of the user and the destination number for the recipient specified in the call arrangement request.

4. The method of claim 1, in which the call arrangement request further identifies a routing rule previously stored in the routing system, and the routing system assigns the routing rule identified in the call arrangement request to the call.

5. The method of claim 1, in which step (a) further comprises the step of the routing system determining the source number

6. The method of claim 5, in which the routing system determines the source number using caller ID.

7. The method of claim 5, in which the source number comprises part of the call arrangement request.

8. The method of claim 1, in which in step (c) the access number is selected from a list of available access numbers.

9. The method of claim 8, in which the access number is selected randomly from the list.

10. The method of claim 1, in which in step (f) the call handling system identifies the call by determining the source number from which the call was placed using Caller ID.
